(19) United States
(12) Patent Application Publication
(10) Pub. No.: US 2024/0020651 A1
(43) Pub. Date: Jan. 18, 2024

(54) SOCIAL NETWORKING METHOD WITH GLOBAL SCHEDULING CAPABILITIES

(71) Applicant: HSIN-YA HUNG, Taichung City (TW)

(72) Inventor: HSIN-YA HUNG, Taichung City (TW)

(21) Appl. No.: 17/865,498

(22) Filed: Jul. 15, 2022

(51) Int. Cl. G06Q 10/10; G06Q 50/00

(52) U.S. Cl. CPC G06Q 10/1095; G06Q 50/01

(57) ABSTRACT

The present invention include steps of loading a first profile with a first profile information, a first time zone information, and a first available schedule on a first device; receiving an appointment request and a second profile corresponding to the appointment request; wherein the second profile includes a second profile information and a second time zone information, and the appointment request includes an appointment time information corresponding to the second time zone information; determining whether a localized appointment time information corresponding to the first time zone information is included in the first available schedule; if excluded, declining the appointment request; if included, accepting the appointment request and generating a first appointment information; the present invention allows a second user of the second profile to know when to expect communication availability of a first user of the first profile, and hence allows scheduling of live communications across different time zones.

### BACKGROUND OF THE INVENTION

### 1. Field of the Invention

The present invention relates to a social networking method, more particularly a social networking method with global scheduling capabilities.

### 2. Description of the Related Art

With ever expansion of globalization, international interactions, such as students studying abroad, industries maintaining stable foreign supply chains, or agencies advertising tourist destinations, all require cross-cultural communications. These cross-cultural communications often take place across different time zones, and are often facilitated through a social networking method.

However, despite understanding that time zone differences exist, lives of cross-cultural communicators are not made simpler to communicate with each other through the current social networking method. Namely, when a local person in the local time wants to initiate a conversation with a foreign person in a different time zone, the local person has to manually check what time zone the foreign person is in, calculate a foreign time corresponding to the time zone the foreign person is in, make a wild guess if the foreign person is sleeping or work occupied, and only then decides whether to proceed attempting to communicate with the foreign person.

These series of actions are inconveniences that every cross-cultural communicator experiences. To avoid the inconvenience of having to figure out whether the foreign person is available for real-time live communications at a certain local time, the current social networking method needs to be improved, so that the local person can know ahead of time when the foreign person would be available.

### SUMMARY OF THE INVENTION

The present invention provides a social networking method with global scheduling capabilities. The present invention allows a user to know when to expect communication availability of another user, and therefore the present invention is able to successfully facilitate real-time live communications between the two users across different time-zones.

The social networking method with global scheduling capabilities includes the following steps:
step S10: loading a first profile; wherein the first profile includes a first profile information, a first time zone information, and a first available schedule; wherein the first available schedule corresponds to the first time zone information, and includes a default free time of one day;
step S20: receiving an appointment request and a second profile corresponding to the appointment request; wherein the second profile includes a second profile information and a second time zone information, and the appointment request includes an appointment time information corresponding to the second time zone information;
step S30: determining a localized appointment time information corresponding to the first time zone information according to the first time zone information, the second time zone information, and the appointment time information;
step S40: determining whether the localized appointment time information is included in the first available schedule;
step S50: when determining the localized appointment time information is excluded from the first available schedule, declining the appointment request;
step S60: when determining the localized appointment time information is included in the first available schedule, accepting the appointment request, and generating a first appointment information corresponding to the first profile.

By taking into account time zone differences between the first profile and the second profile, the present invention is able to adjust the appointment time information corresponding to the second time zone information of the second profile to the localized appointment time information corresponding to the first time zone information of the first profile. Furthermore, the present invention determines whether the localized appointment time information is included in the first available schedule, so as to determine whether the first profile would be available for scheduling an appointment with the second profile.

The present invention allows a second user of the second profile to know when to expect communication availability of a first user of the first profile, and therefore the present invention is able to successfully facilitate real-time live communications between the two users across different time-zones. This way, the present invention is able to provide global scheduling capabilities, with an appointment time adjustment across different time-zones and a determination of time availability for an appointment.

### BRIEF DESCRIPTION OF THE DRAWINGS

FIG. 1 is a block diagram of a system executing a social networking method with global scheduling capabilities.

FIG. 2 is a flow chart of the social networking method with global scheduling capabilities executed by a first device.

FIG. 3 is a flow chart of the social networking method with global scheduling capabilities executed by a second device.

FIG. 4A is another flow chart of the social networking method with global scheduling capabilities executed by the first device.

FIG. 4B is another flow chart of the social networking method with global scheduling capabilities executed by the first device.

FIG. 5 is another flow chart of the social networking method with global scheduling capabilities executed by the first device.

FIG. 6 is another flow chart of the social networking method with global scheduling capabilities executed by the first device.

FIG. 7 is a perspective view of a main page generated by the social networking method with global scheduling capabilities.

FIG. 8 is a perspective view of a communications page generated by the social networking method with global scheduling capabilities.

FIG. 9 is a perspective view of a personalized feed page generated by the social networking method with global scheduling capabilities.

FIG. 10 is a perspective view of a scheduling page generated by the social networking method with global scheduling capabilities.

FIG. 11 is another perspective view of the scheduling page generated by the social networking method with global scheduling capabilities.

### DETAILED DESCRIPTION OF THE INVENTION

The present invention provides a social networking method with global scheduling capabilities.

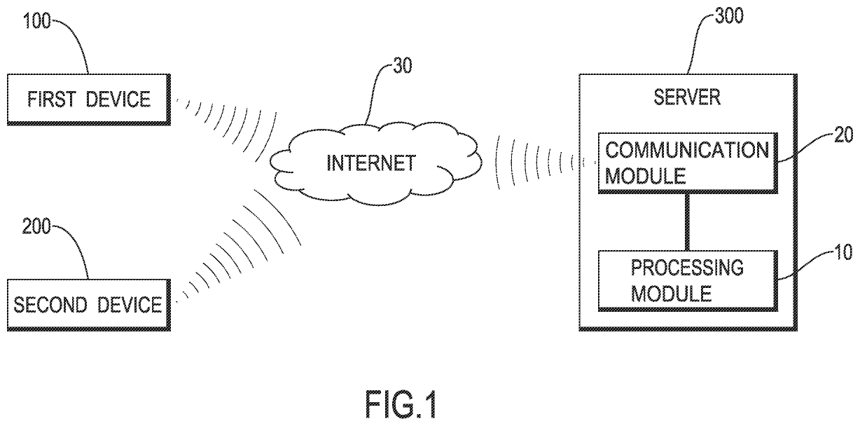

With reference to FIG. 1, the social networking method with global scheduling capabilities is executed by a first device 100. The first device 100 is communicatively connected to a second device 200 and a server 300 through an internet 30. The server 300 includes a processing module 10 and a communication module 20. The communication module 20 is electrically connected to the processing module 10.

In an embodiment of the present invention, the first device 100 and the second device 200 are electronic devices connectable to the internet, more particularly, smart devices, such as smart phones, tablet computers, or AR/VR devices. The social networking method with global scheduling capabilities is executed by the first device 100 installing an application (APP). The APP is installed both on the first device 100 and the second device 200, and the APP is executed locally with a processing unit of a smart device. User related information and big data gathered from the APP is collected by the server 300 through the communication module 20 from the first device 100 and the second device 200 via the internet 30, and then processed by the processing module 10.

For example, the first device 100 is a smart device owned by a first user, and the second device 200 is another smart device owned by a second user. The APP installed on the first device 100 tries to personalize settings for the first user, and likewise, the APP installed on the second device 200 also tries to personalize settings for the second user. This way, the first device 100 is more conveniently accessible for the first user and the second device 200 is more conveniently accessible for the second user.

In another embodiment of the present invention, the first device 100 and the second device 200 are simply computers, and the social networking method with global scheduling capabilities can be accessed via a website. The website accepts an account and a password for identity authentication, so as to distinguish whether the website is being accessed by the first user of the first device 100 or the second user of the second device 200 or elsewise.

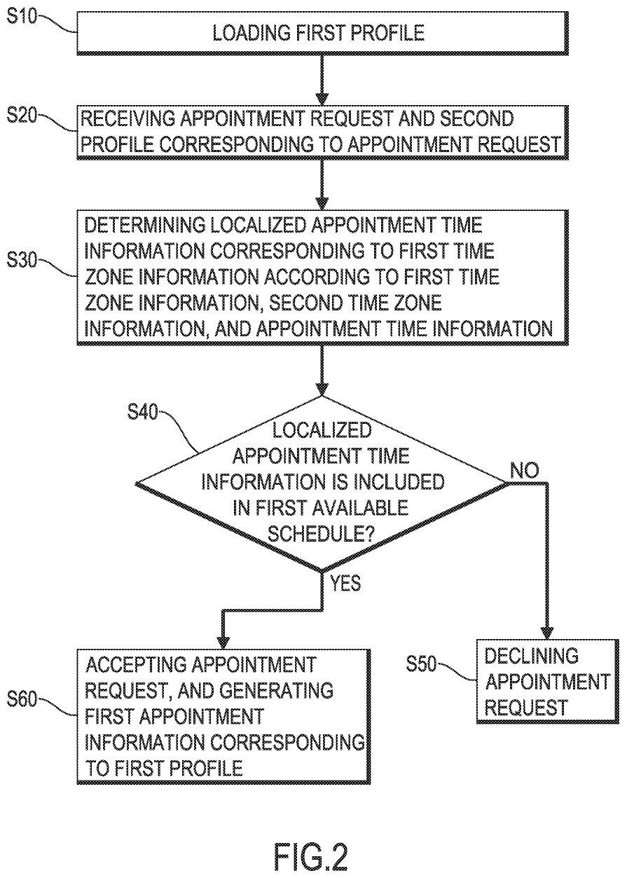

With reference to FIG. 2, the social networking method with global scheduling capabilities includes the following steps:

Step S10: loading a first profile. The first profile includes a first profile information, a first time zone information, and a first available schedule. The first available schedule corresponds to the first time zone information, and includes a default free time of one day.

The first profile is loading into the first device 100 via the APP. The first profile is a digital profile of the first user owning the first device 100. The first time zone information is gathered from localization of the first device 100. In other words, the first device 100, as a smart device or a computer connectable to the internet, is equipped with a localized time information. The localized time information is fetched by the APP as the first time zone information. As a result, the first time zone information signifies a time zone the first user is in. For ease of reference, the first user is set to be in a first time zone.

The first available schedule is a default schedule for the first user generated by the present invention. The first available schedule follows a common schedule established by the majority of people known as the default schedule, namely, during the default free time of a day, the majority of people statistically would be free and available for scheduling appointments. The default schedule is pre-configured by the processing module 10 according to the big data gathered from different devices. The default schedule may be modified by a system administrator of the processing module 10. In the present embodiment, the default free time is when a person typically is awake, as opposed to being asleep. The first profile information includes a name information of the first user, and more particularly, the name information is a nickname.

The first available schedule corresponds to the first time zone information as the first available schedule signifies a schedule for the first user described in the first time zone, and the first time zone is described by the first time zone information.

Step S20: receiving an appointment request and a second profile corresponding to the appointment request. The second profile includes a second profile information and a second time zone information, and the appointment request includes an appointment time information corresponding to the second time zone information.

In other words, the second user of the second device 200 logged in with the second profile sends the appointment request to the first user of the first device logged in with the first profile. The second profile is a digital profile of the second user owning the second device 200. The second profile information includes a name information of the second user. Step S20 is written in the perspective of the first device 100 receiving the appointment request and the second profile from the second device 200. The appointment request corresponds to the second profile because the request is generated under the second profile that is logged in by the second user using the second device 200. The second time zone information is gathered from localization of the second device 200. The second time zone information signifies a time zone the second user is in. For ease of reference, the second user is set to be in a second time zone. The appointment time information signifies an appointment time set in the second time zone. In this embodiment, the second time zone is different than the first time zone. In another embodiment, the second time zone is the same time zone as the first time zone.

The appointment time information corresponds to the second time zone information because the appointment time information describes an appointment time in the second time zone, and the second time zone is described by the second time zone information.

Step S30: determining a localized appointment time information corresponding to the first time zone information according to the first time zone information, the second time zone information, and the appointment time information.

In other words, since the appointment time information is the appointment time set in the second time zone, the present invention personalizes this information for the first user by converting the appointment time information to the localized appointment time information, so as to provide the first user a localized appointment time scheduled in the first time zone.

The localized appointment time information corresponds to the first time zone information because the localized appointment time information describes an appointment time in the first time zone, and the first time zone is described by the first time zone information.

Step S40: determining whether the localized appointment time information is included in the first available schedule.

Step S50: when determining the localized appointment time information is excluded from the first available schedule, declining the appointment request.

In other words, step S50 is executed by the first device 100 to automatically decline the appointment request from the second device 200 because according to the first available schedule, the localized appointment time is outside of the default free time of one day, and so the first user is assumed to be occupied and unavailable for any appointments.

Step S60: when determining the localized appointment time information is included in the first available schedule, accepting the appointment request, and generating a first appointment information corresponding to the first profile.

In other words, step S60 is executed to set up an appointment between the first user and the second user since the localized appointment time information is in the default free time, meaning the first user is assumed to be available for appointments. The first appointment information corresponds to the first profile because the first appointment information is generated by the first device 100 logged in with the first profile by the first user. The first appointment information describes to the first user logged in with the first profile about an upcoming appointment scheduled with the second user.

By taking into account time zone differences between the first user and the second user, or a time difference between the first time zone and the second time zone, the present invention is able to adjust the appointment time information in the second time zone to the localized appointment time information in the first time zone. Furthermore, the present invention determines whether the localized appointment time information is included in the first available schedule, so as to determine whether the first user would be available for scheduling an appointment with the second user.

The present invention allows the second user of the second device 200 logged in with the second profile to know when to expect communication availability of the first user of the first device 100 logged in with the first profile, and therefore the present invention is able to successfully facilitate real-time live communications between the two users across different time-zones. This way, the present invention is able to provide global scheduling capabilities, with the appointment time adjustment across different time-zones and a determination of time availability for an appointment.

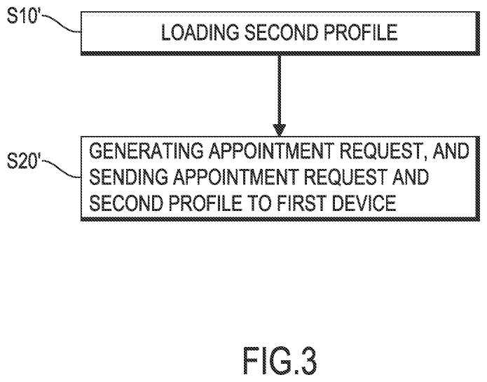

With reference to FIG. 3, to clarify the execution of the present invention in different devices, FIG. 3 corresponds to the execution of the present invention installed in the second device 200, while FIG. 2 corresponds to the execution of the present invention installed in the first device 100.

The second device 200 executes the following steps to send the appointment request to the first device 100:

Step S10′: loading the second profile. The second profile includes the second profile information, the first time zone information, and a second available schedule. The second available schedule includes the default free time of a day defined in the second time zone.

Step S20′: generating the appointment request, and sending the appointment request and the second profile corresponding to the appointment request from the second device 200 to the first device 100 via the internet 30.

In the present embodiment, a user authentication process is added for the APP executed respectively by the first device 100 and the second device 200. The user authentication process is password unlocked, and the password may be a pin code, a combination of different codes, a facial feature, or a thumbnail. For the password in the form of facial feature, a camera is needed for the first device 100 for facial recognition. For the password in the form of thumbnail, a finger scanner is needed for the first device 100 for thumbnail recognition.

The user authentication process verifies whether the first user is using the first device 100, and whether the second user is using the second device 200. If the first user is verified, the first device 100 logs into the first profile and therefore loads the first profile from the processing module 10 via the communication module 20 and the internet 30. If the first user has already logged into the first profile previously on the first device 100 and stays logged in, then when opening and executing the APP, the first profile is loaded from memory of the first device 100 instead, before being updated from the internet 30. If the first user fails the authentication process, then the first profile would be blocked from loading into the first device 100. The user authentication process works in similar logic for the second user owning the second device 200.

Furthermore, in the present embodiment, the default free time includes a first time period defined by a first starting time and a first ending time and a second time period defined by a second starting time and a second ending time. The first time period and the second time period both define free time when a user is available for appointments. In the embodiment, the first time period is a time when the user is awake after work, and the second time period is a time when the user is awake during lunch break. The first starting time is 6 pm, the first ending time is 11 pm, and the second starting time is 1 pm to 1:30 pm. In other embodiments, the first time period and the second time period may be elsewise, and also the default free time may include more different time periods to define free time periods.

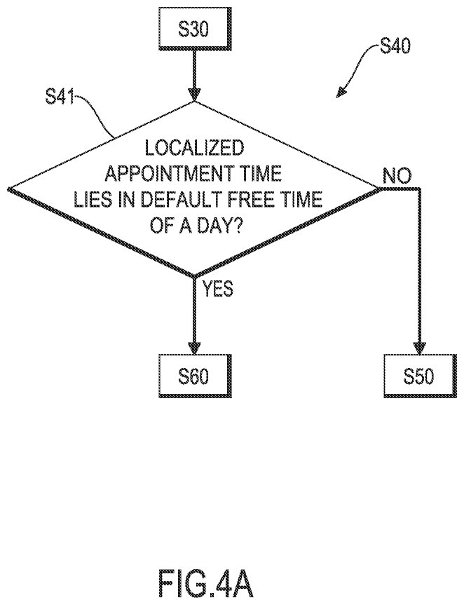

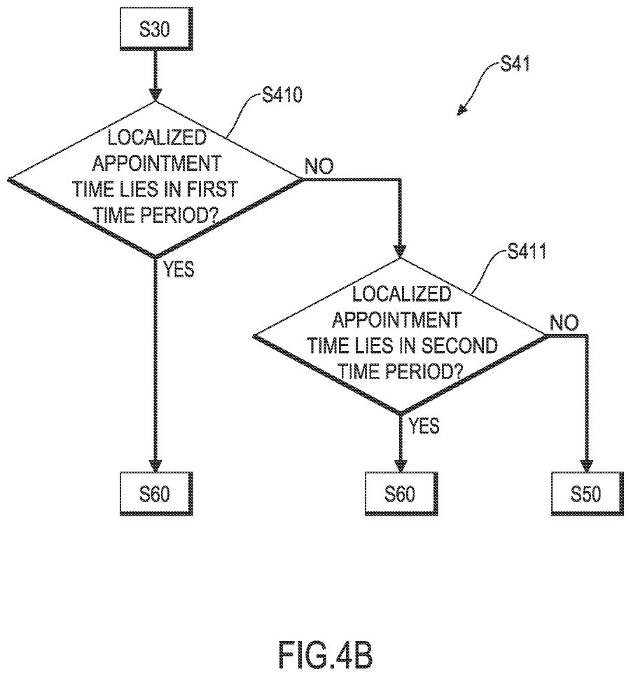

With reference to FIG. 4A, when the first device 100 executes step S40, the first device 100 executes the following sub-step:

Step S41: determining whether the localized appointment time lies in the default free time of a day.

If determining the localized appointment time lies outside of the default free time of a day, then execute step S50.

If determining the localized appointment time lies in the default free time of a day, then execute step S60.

With reference to FIG. 4B, when the first device 100 executes step S41, the first device 100 determines whether the localized appointment time lies in any of the periods included in the default free time of a day. In this embodiment, the first device 100 executes the following sub-step:

Step S410: determining whether the localized appointment time lies in the first time period.

When determining the localized appointment time information lies in the first time period, executing step S60.

Step S411: when the localized appointment time information lies outside of the first time period, further determining whether the localized appointment time information lies in the second time period.

When determining the localized appointment time information lies outside of the second time period, executing step S50.

When determining the localized appointment time information lies in the second time period, executing step S60.

After the appointment request is accepted and the appointment information is generated, when it is time for the appointment, the present invention would initiate a video chat between participants of the appointment. In this case, the present invention would initiate a video chat between the first user of the first device 100 and the second user of the second device 200. In other embodiments, the present invention initiates a voice chat instead of a video chat.

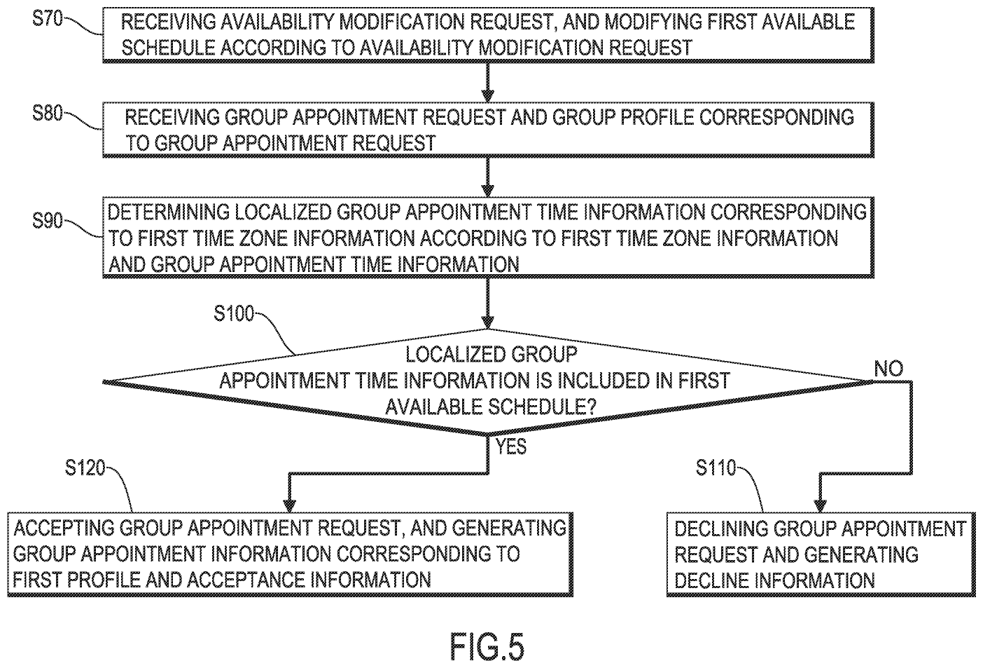

With reference to FIG. 5, the present invention includes the following steps:

Step S70: receiving an availability modification request, and modifying the first available schedule according to the availability modification request. In other words, in this embodiment, modifying the first starting time, the first ending time, the second starting time, and the second ending time according to the availability modification request.

In an example, according to the availability modification request, the first starting time is modified to change from 6 pm to 4 pm, changing the first time period. Through the availability modification request, the first device 100 is further personalized for the first user with modified settings, better defining times when the first user is available for appointments.

Step S80: receiving a group appointment request and a group profile corresponding to the group appointment request. The group profile includes a group profile information and a group time zone information, and the group appointment request includes a group appointment time information corresponding to the group time zone information.

The group profile includes a collection of multiple profiles. In other words, the group profile is a group made up of the multiple profiles as members, and each of the multiple profiles corresponds to a user in a time zone as a member. Among the multiple profiles that make up the group, one of the members is the first profile that corresponds to the first user using the first device 100 in the first time zone. The group profile information includes a name information of the group. The group appointment request is generated by one of the group members among the multiple profiles, and the group appointment time information corresponds to the said member who generated the group appointment request. The group time zone information includes a collection of multiple time zone information, and each of the multiple time zone information corresponds to one of the multiple profile information, or rather more particularly, each of the multiple time zone information corresponds to each of the multiple profile information associated with the group.

For instance, if the second profile is also one of the members of the group, then the group time zone information would include the first time zone information and the second time zone information. Furthermore, if the second user using the second device 200 logs in as the second profile generated the group appointment request, then the group appointment time information corresponds to the second time zone information. In other words, the group appointment time information would be scheduled according to a time in the second time zone.

The group profile corresponds to the group appointment request because, as described, one of the members of the group described by the group profile can initiate the group appointment request. Furthermore, the group appointment time information corresponds to the group time zone information as the member who initiates the group appointment request is in a time zone described by the group time zone information, and the group appointment time information is described in the said time zone.

Step S90: determining a localized group appointment time information corresponding to the first time zone information according to the first time zone information and the group appointment time information.

Since the first profile is a member of the group profile, after receiving the group appointment request, the present invention would be executed by the first device 100 to localize and personalize for the first user corresponding to the first profile. The localized group appointment time information signifies a group appointment time equivalent in the first time zone for the first user.

The localized group appointment time information corresponds to the first time zone information as the localized group appointment time information is described in the first time zone for the first user with the first device 100 logged in with the first profile, and the first time zone is described by the first time zone information.

Step S100: determining whether the localized group appointment time information is included in the first available schedule. Step S100 is designed in similar idea as step S40, to check availability for appointments for the first user.

Step S110: when determining the localized group appointment time information is excluded from the first available schedule, declining the group appointment request and generating a decline information. Step S110 is similar to step S50 in that when determining the first user is occupied for the intended appointment time, the present invention automatically declines requests. After declining the group appointment request, the first profile generates the decline information, so as to indicate that the first user is unavailable for the group appointment request.

Step S120: when determining the localized group appointment time information is included in the first available schedule, accepting the appointment request, and generating a group appointment information corresponding to the first profile and an acceptance information.

The acceptance information indicates that the first user is unavailable for the group appointment request. The acceptance information or the decline information would be sent to the processing module 10 from the first device 100 via the internet 30 and the communication module 20. Once the processing module 10 gathers that each member of the group profile sends the acceptance information, the group appointment information would be established by the processing module 10, and the group appointment information would be generated locally too, as the group appointment information corresponding to the first profile would be generated locally by the first device 100. As such, the processing module 10 successfully sets up a group appointment between all of the group members, or in other words between all of the profiles making up the group profile. When time comes for the group appointment, a video chat or a voice chat would initiate between all of the group members.

The group appointment information corresponds to the first profile because the group appointment information describes the group appointment for the first user with the first device 100 logged in with the first profile.

Furthermore, the first profile information further includes a profile picture of the first user, a signature information of the first user, a location information of the first user, a personal communication information of the first user, an active appointment information of the first user, an employment affiliation information of the first user, a friend list information of the first user, a joined group information of the first user, a personalized setting information of the first user, and a favorite friends information of the first user for the first profile.

The friend list information of the first user signifies other profiles connected to the first profile, in other words, who are friends to the first user. The first device 100 and the second device 200 are connected through the internet 30 because the first user and the second user are friends according to the friend list information, as the first profile is linked to the second profile according to the friend list information. The favorite friends information determines whether each of the other profiles is listed as a favorite friend or a normal friend to the first user of the first profile. In other words, each of the friends of the first user, or each of the other profiles connected to the first profile according to the friend list information would be split into either a favorite friend category or a normal friend category. By default, all of the other profiles connected to the first profile are in the normal friend category, and through the first user's modification, a friend and its corresponding profile can be updated to be in the favorite friend category. Furthermore, the personal communication information includes messages between the first profile and the other profiles.

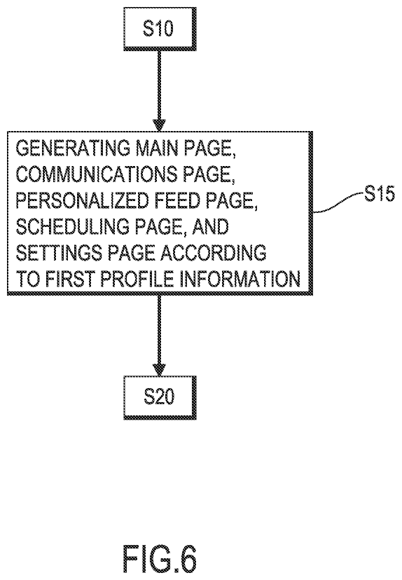

With reference to FIG. 6, in the present embodiment, the present invention further includes the following step between steps S10 and S20:

Step S15: generating a main page, a communications page, a personalized feed page, a scheduling page, and a settings page according to the first profile information.

In an embodiment of the present invention, the pages generated in S15 are webpages. In another embodiment of the present invention, the pages generated in S15 are screenshots of different options in the APP.

The following perspective views of screenshots from the first device 100 is included to better demonstrate how the present invention is presented to the first user.

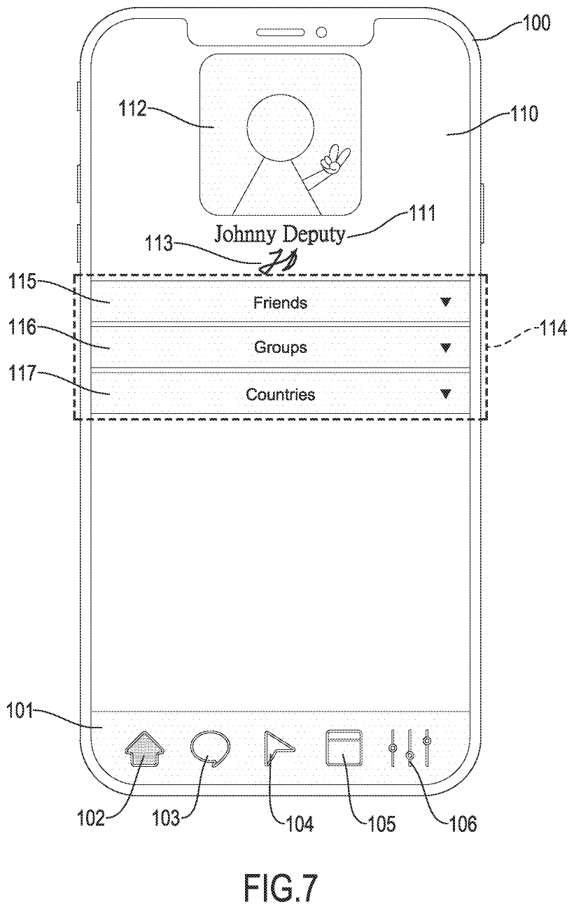

With reference to FIG. 7, the main page 110 is displayed on the first device 100. The main page 110 displays the name information 111, the profile picture 112, the signature information 113, and the friend list information 114 of the first user. The main page 110 organizes a friends tab 115, a groups tab 116, and a countries tab 117. Each of the tabs 115, 116, 117 can be expanded for extensive display or condensed for minimal display. In this example, the name information 111 for the first user is Johnny Deputy.

The main page also further organizes the friends tab 115 according to the favorite friends information, by listing the other profiles in terms of favorite friends and normal friends. The profiles corresponding to the favorite friends would be located near top of the friends tab 115, while the profiles corresponding to the normal friends would be located below the favorited profiles, as the present invention prioritizes showing the favorite friends to the first user in expanded version of the friends tab 115.

The groups tab 116 displays the other profiles corresponding to the joined group information of the first profile information. The countries tab 117 displays the location information of the other profiles. The location information signifies countries wherein the other profiles are each localized in.

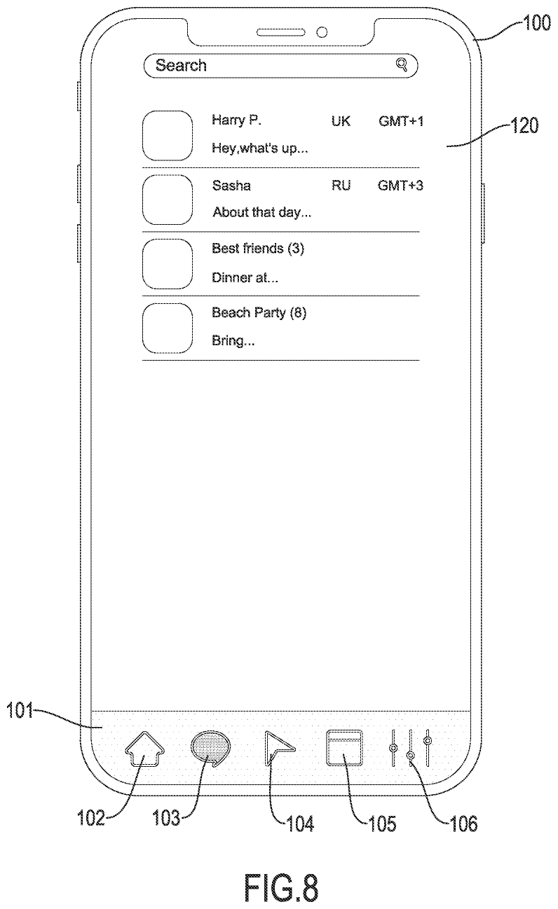

With reference to FIG. 8, the communications page 120 displays the messages between the first profile and the other profiles. Each message displays a time zone each of the profiles is in.

More particularly, in this example, some of the messages the first profile receives are from individual profiles, such as Harry P.'s profile or Sasha's profile, and some other messages are from groups, such as Best friends with three members or Beach Party with eight members. Since messages to individual profiles are private one to one chats, meaning that only one time zone is needed to be accounted, and therefore the communications page 120 displays the time zone Harry P. is in, and the time zone Sasha is in. In this example, Harry P. is localized in United Kingdom with GMT+1 time zone, and Sasha is localized in RU with GMT+3 time zone. Since messages to groups are aimed for multiple profiles, the communications page 120 omits displaying all of the time zones corresponding to the profiles in the group but only displays the time zones of group members when the group members are displayed in a list.

Each of the profiles described in the present invention signifies a device logged in with a profile by a user in similar logic as the first user using the first device 100 logged in with the first profile and the second user using the second device 200 logged in with the second profile.

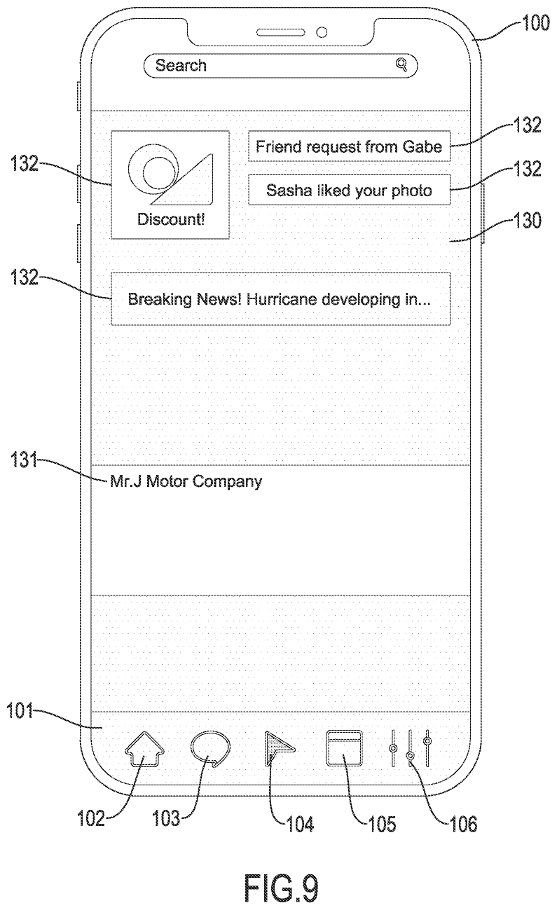

With reference to FIG. 9, the personalized feed page 130 displays the employment affiliation information 131 of the first profile information, as well as live feeds 132 personalized for the first profile. The live feeds 132 are generated by the processing module 10 by using the big data gathered from the first device 100 and the first profile. The live feeds 132 include news, commercials, and notifications for the first user from other social networking media.

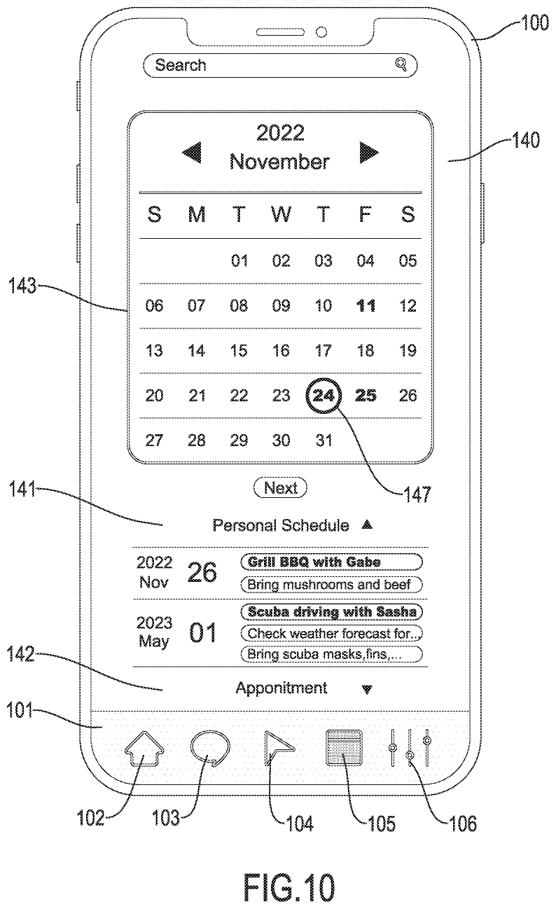

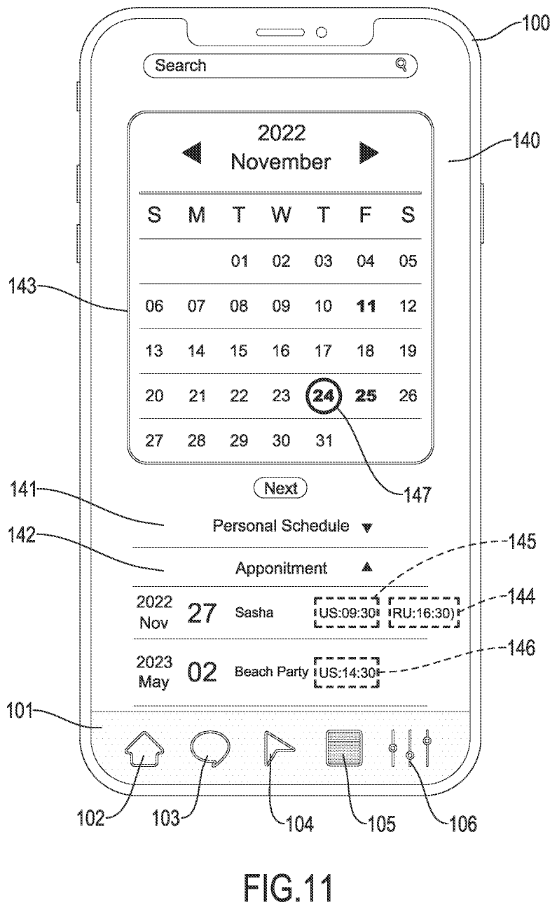

With reference to FIGS. 10 and 11, the scheduling page 140 displays a personal schedule of the first profile 141, the active appointment information 142 of the first profile information, and a calendar 143 with a current time and date corresponding to the first profile. The active appointment information 142 signifies the generated appointment time information scheduled in future from the current time.

Furthermore, the generated appointment time information displays both the appointment time information 144 and the localized appointment time information 145, as well as the localized group appointment time information 146.

In this embodiment, the personal schedule of the first profile 141 is simply digital notes of memo the first user created for oneself. These memos are saved digitally as events, each with a title, a description, and a date.

In FIG. 11, as an example, the active appointment information 142 includes an appointment event with Sasha and a group appointment event with the Beach Party group. For the appointment event with Sasha, the present invention displays both in Sasha's time zone as 16:30 military time and in the first user's time zone as 09:30 military time. For the group appointment event with the Beach Party group, the present invention simply displays in the first user's time zone as 14:30 military time. In this example, both 09:30 and 14:30 military time are included in the first available schedule. Sasha's time zone is Moscow's time zone in Russia, and the first user's time zone is New York's time zone in the United States.

The calendar 143 corresponding to the current time and date of the first device 100, in other words the calendar 143 described in the first time zone, would also be localized to have holiday information for the first user. A current date 147 is also marked on the calendar for the ease of recognizing what time in a month the current date 147 is. In this example, the current date 147 is displayed as Nov. 24, 2022. Since the first user is localized in the United States, dates such as Nov. 11, 24, and 25, 2022 are marked with bold font in the calendar 143. These marked dates respectively represent holidays in November 2022, more particularly, these marked dates respectively represent Veterans Day, Thanksgiving, and a day after Thanksgiving in November 2022.

The present invention may also receive a date modification request for adjusting holiday days marked in the calendar 143. For instance, if the first user is a student, then the calendar 143 may be modified to include summer vacation and winter vacation dates in the calendar 143.

Each of the main page 110, the communications page 120, the personalized feed page 130, the scheduling page 140, and the settings page includes a bar 101 to switch between the said pages. The bar 101 includes a main page button 102, a communications page button 103, a personalized feed page button 104, a scheduling page button 105, and a settings page button 106 available for selection to switch between the main page 110, the communications page 120, the personalized feed page 130, the scheduling page 140, and the settings page.

The present invention may also receive a privacy adjustment request to modify privacy settings for the first profile. For instance, if the first user wishes to hide his/her birthday date from the other profiles, then the present invention would be able to hide the birthday date according to the privacy adjustment request. If the birthday date is public, then the first user's birthday date would be shared to the first user's friends, such as the second user of the second profile. In this case, the second device 200 would receive a notification regarding the first profile's upcoming birthday from the processing module 10, and the first user's birthday date would be displayed in the second user's calendar in the scheduling page 140 personalized for the second user.

The above embodiments serve to demonstrate different possible examples used for executing the social networking method with global scheduling capabilities, rather than limitations imposed to the present invention. Any simple modifications or equivalent changes made to the present invention would still be encompassed by what is claimed for the present invention and protected by what is claimed by the present invention.

What is claimed is:

1. A social networking method with global scheduling capabilities, executed by a first device, and comprising the following steps:
step S10: loading a first profile; wherein the first profile includes a first profile information, a first time zone information, and a first available schedule; wherein the first available schedule corresponds to the first time zone information, and includes a default free time of one day;
step S20: receiving an appointment request and a second profile corresponding to the appointment request; wherein the second profile includes a second profile information and a second time zone information, and the appointment request includes an appointment time information corresponding to the second time zone information;
step S30: determining a localized appointment time information corresponding to the first time zone information according to the first time zone information, the second time zone information, and the appointment time information;
step S40: determining whether the localized appointment time information is included in the first available schedule;
step S50: when determining the localized appointment time information is excluded from the first available schedule, declining the appointment request;
step S60: when determining the localized appointment time information is included in the first available schedule, accepting the appointment request, and generating a first appointment information corresponding to the first profile.

2. The social networking method with global scheduling capabilities as claimed in claim 1, wherein:
the default free time of one day includes a first time period defined by a first starting time and a first ending time;
when the localized appointment time information lies in the first time period, the localized appointment time information is determined to be included in the first available schedule, and step S60 is executed.

3. The social networking method with global scheduling capabilities as claimed in claim 2, further comprising the following step:
step S70: receiving an availability modification request, and modifying the first available schedule according to the availability modification request.

4. The social networking method with global scheduling capabilities as claimed in claim 2, wherein:
the default free time of one day includes a second time period defined by a second starting time and a second ending time;
the social networking method further comprises the following steps:
when the localized appointment time information lies outside of the first time period, determining whether the localized appointment time information lies in the second time period;
when the localized appointment time information lies outside of the second time period, executing step S50;
when the localized appointment time information lies in the second time period, executing step S60.

5. The social networking method with global scheduling capabilities as claimed in claim 4, further comprising the following step:
step S70: receiving an availability modification request, and modifying the first available schedule according to the availability modification request.

6. The social networking method with global scheduling capabilities as claimed in claim 1, further comprising the following steps:
step S80: receiving a group appointment request and a group profile corresponding to the group appointment request; wherein the group profile includes a group profile information and a group time zone information, and the group appointment request includes a group appointment time information corresponding to the group time zone information;
step S90: determining a localized group appointment time information corresponding to the first time zone information according to the first time zone information and the group appointment time information;
step S100: determining whether the localized group appointment time information is included in the first available schedule;
step S110: when determining the localized group appointment time information is excluded from the first available schedule, declining the group appointment request;
step S120: When determining the localized group appointment time information is included in the first available schedule, accepting the group appointment request, and generating a group appointment information corresponding to the first profile.

7. The social networking method with global scheduling capabilities as claimed in claim 6, wherein:
the group profile includes a collection of multiple profiles, and one of the multiple profiles is the first profile;
the group time zone information includes a collection of multiple time zone information, and each of the multiple time zone information corresponds to one of the multiple profile information.

8. The social networking method with global scheduling capabilities as claimed in claim 1, wherein the first device is a smart device installing an application.

9. The social networking method with global scheduling capabilities as claimed in claim 1, wherein:
the first profile information includes a name information, a profile picture, a signature information, a location information, a personal communication information, an active appointment information, an employment affiliation information, a friend list information, a joined group information, and a personalized setting information.

10. The social networking method with global scheduling capabilities as claimed in claim 9, further comprising the following steps:
step S15: generating a main page, a communications page, a personalized feed page, a scheduling page, and a settings page according to the first profile.

11. The social networking method with global scheduling capabilities as claimed in claim 10, wherein:
the main page displays the name information, the profile picture, the signature information, and the friend list information of the first profile information.

12. The social networking method with global scheduling capabilities as claimed in claim 10, wherein:
when the main page displays the friend list information of the first profile information, the main page organizes a friends tab, a groups tab, and a countries tab;
the groups tab displays the other profiles corresponding to the joined group information of the first profile information;
the countries tab displays the location information corresponding to the other profiles; the location information signifies countries the other profiles are each localized in.

13. The social networking method with global scheduling capabilities as claimed in claim 12, wherein:
the first profile also includes a favorite friends information; the favorite friends information determines whether each of the other profiles is listed as a favorite friend or a normal friend to the first profile;
when the main page displays the friend list information of the first profile information, the main page also organizes the friends tab according to the favorite friends information, by listing the other profiles in terms of favorite friends and normal friends.

14. The social networking method with global scheduling capabilities as claimed in claim 10, wherein:
the personal communication information includes messages between the first profile and the other profiles;
the communications page displays the messages between the first profile and the other profiles, and each message displays a tune zone each of the profiles is in.

15. The social networking method with global scheduling capabilities as claimed in claim 10, wherein:
the personalized feed page displays the employment affiliation information of the first profile information, as well as live feed personalized for the first profile.

16. The social networking method with global scheduling capabilities as claimed in claim 10, wherein:
the scheduling page displays the active appointment information of the first profile information and a calendar with a current time corresponding to the first profile;
the active appointment information is a collection of the first appointment time information scheduled in future from the current time.

17. The social networking method with global scheduling capabilities as claimed in claim 16, wherein:
the active appointment information displays both the appointment time information and the localized appointment time information corresponding to each of the first appointment time information.
